(19) United States
(12) Patent Application Publication
(10) Pub. No.: US 2026/0216913 A1
(43) Pub. Date: Jul. 30, 2026

(54) APPARATUS FOR ADDITIVE MANUFACTURING OF REINFORCED STRUCTURES AND A METHOD FOR ADDITIVE MANUFACTURING OF REINFORCED STRUCTURES

(71) Applicant: Knauf Gips KG, Iphofen (DE)

(72) Inventors: Arsalan Iqbal, Iphofen (DE); Raphael Geiger, Iphofen (DE); Rauno Baese, Iphofen (DE); Christian Engert, Iphofen (DE); Michael Göbel, Iphofen (DE)

(21) Appl. No.: 19/139,071

(22) PCT Filed: Dec. 14, 2022
(86) PCT No.: PCT/EP2022/025572

§ 371 Date: Jun. 13, 2025

(51) Int. Cl. B28B 1/00; B28B 3/26; B33Y 10/00; B33Y 30/00

(52) U.S. Cl. CPC B28B 1/001; B28B 3/2645; B33Y 10/00; B33Y 30/00

(57) ABSTRACT

The invention relates to an apparatus (1) for additive manufacturing of reinforced structures, comprising a nozzle device (2) for extruding a building material (21) along a print direction (X) and a fiber device (3) for providing a reinforcement metal fibre (41) of a predetermined length from a continuous metal wire (42), wherein the apparatus (1) further comprises a movement unit (5) having arranged thereon the nozzle device (2) and the fibre device (3) in a manner so that during a movement in the print direction (X), the fibre device (3) places the reinforcement metal fibre (41) at the building material (21) extruded by the nozzle device (2).

The invention relates to an apparatus for additive manufacturing of reinforced structures and a method for additive manufacturing of reinforced structures according to the respective independent claim.

The technical field relates to construction of buildings and in particular structures comprising a reinforcement for example in 3D concrete printing. 3D concrete printing is a fully automated solution, regarding the extrusion of 3D mortar. In general, it is known that there is a gap as reinforcement in 3D concrete is not yet possible in the same grade of automation in particular when it comes to extrusion and reinforcing in one automated process.

It is known in 3D concrete printing for example from EP 4035857A 1 to print surfaces (planes and curves) by spraying fiber reinforced concrete. Spraying is done by means of a spray gun which cuts continuous fiber strands and mix them with concrete in the nozzle itself. The disadvantages related thereto is that the fibres are not placed in a manner so as to have a specific orientation. That random orientation makes the reinforcement only calculable with large tolerances so that the static of structures made of these materials cannot be reliably calculated. Furthermore, a process as disclosed in EP 4035857A1 requires fibres that can be sprayed together with the mortar. Therefore, size and weight of the processible fibers is limited.

In another conventional method, as for example shown in US 2022 055 249 A1 an automated reinforcement of concrete structures by use a 3D printed fibre is disclosed. The fibre is made of a glass, carbon, basalt, aramid, diolen and can be arranged in a chemosetting saturant mixture, thermoplast, photocurable plastic or thermosetting plastic. A disadvantage related thereto is that the fiber material is expensive. In addition, the reinforcement material is not known in practical applications in the field of construction, in particular in regard to long term stability.

To overcome or at least reduce the problems known in the prior art, the invention provides an apparatus for additive manufacturing of reinforced structures and a method for additive manufacturing of reinforced structures according to the respective independent claim. Advantageous aspects are the subject matter of the dependent claims.

The invention comprises an apparatus for additive manufacturing of reinforced structures. The apparatus comprises a nozzle device for extruding a building material along a print direction X and a fiber device for providing a reinforcement metal fibre of a predetermined length from a continuous metal wire. A certain production tolerance is possible. The apparatus further comprises a movement unit having arranged thereon the nozzle device and the fibre device in a manner so that during a movement in the print direction X, the fibre device places the reinforcement metal fibre at the building material extruded by the nozzle device. The apparatus allows automated provision of reinforcements in 3D printed concrete structure. The reinforcement metal fibres (e.g., steel fibres) are easy to handle and can be automatically and simultaneously placed in synchronization with the building material (e.g., mortar) extrusion. That makes it possible to print structures that do not brittle and have considerably high strength and ductility.

According to an advantageous aspect, the fibre device places the reinforcement metal fibre at the building material extruded by the nozzle device during a continuous movement in the print direction X. The separated reinforcement metal fibre are provided in a continuous manner to achieve a high construction speed and quality.

In an alternative way, it is also possible to run the process by first providing the fibers and then printing the mortar on top of the fibers.

Preferably, the fibre device is designed to allow for placing the reinforcement metal fibre in the extruded building material in a manner so that a portion of the reinforcement metal fibre is outside of the building material. In this way, the fibre device can lay the reinforcement metal fibre on a specific position and in a predetermined orientation so that the (subsequently) applied building material covers only a portion thereof. Especially, in addition to prior art, it is possible to place fibers having components in z-direction, perpendicular to the mortar layer area (xy-plane).

Advantageously, the fibre device comprises a wire feeding unit for providing the continuous metal wire from a metal wire storage. The wire feeding unit can comprise to adjacent wheels in between of which the reinforcement wire is moved by rotating the wheels.

Preferably, the fibre device comprises a cutting unit for cutting the continuous metal wire provided from the wire feeding unit into a reinforcement metal fiber of a pre-determined length. The cutting unit comprises a cutting element capable of quickly separating the metal wire.

Another preferred aspect relates to that the cutting unit comprises a continuous cutting element. That can be a rotational cutting wheel with cutting blades.

Preferably, the fibre device comprises a shaping unit capable of forming at least a portion of the reinforcement metal fiber before being placed in the building material. The forming can take place before or after cutting of the reinforcement metal fibre from the continuous metal wire.

Advantageously, the movement unit comprises a robot having a robot arm which is movable in 2D (two spatial dimensions) or 3D (three spatial dimensions). The nozzle device and the fibre device are arranged at a robot arm end. That allows to employ a conventional production robot to achieve a synchrony movement.

The apparatus according to the invention could also be realized by different 3D movement units provided with the nozzle-fibre device unit, for example by a 3D gantry portal or a crane system.

Another way to achieve the advantages of the invention relates to a method for additive manufacturing of reinforced structures, comprising the steps of
a) extruding a building material along a print direction X; and
b) providing a reinforcement metal fibre a predetermined length at the extruded building material.

Preferably, the step b) of providing a reinforcement metal fibre of a predetermined length comprises cutting the reinforcement metal fibre of a predetermined length from a continuous metal wire.

According to an advantageous aspect, the step b) of providing a reinforcement metal fibre of a predetermined length comprises bending one or both end portions and/or a middle portion of the reinforcement metal fibre before being placed in the building material.

Preferably, the step b) of providing a reinforcement metal fibre of a predetermined length comprises placing the reinforcement metal fibre in a manner so that only a portion is inside the extruded building material.

According to another preferred aspect, the method further comprises the step c) extruding a building material along a print direction X at the reinforcement metal fibre of a predetermined length placed at the extruded building material so that so that only a portion is inside the extruded building material in a manner so that the portion outside the extruded building material is covered by the building material extruded in step c).

In the following drawings, the invention is illustrated in context of exemplary embodiments in which,

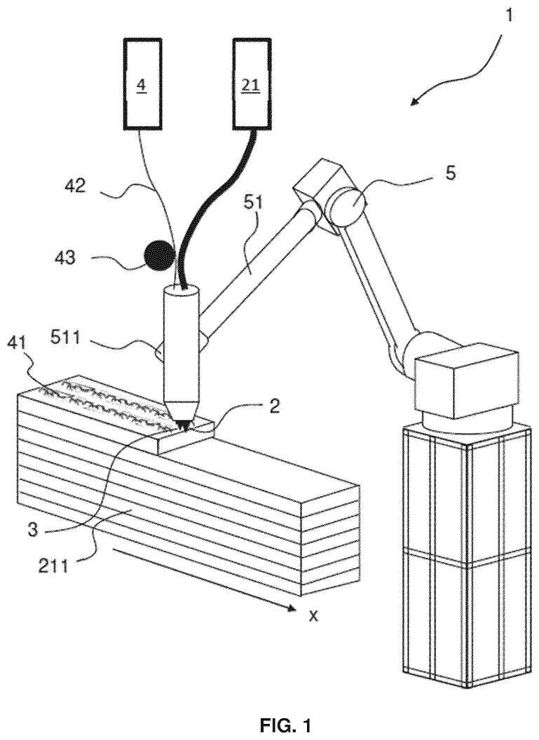

FIG. 1 shows a perspective view of a first exemplary embodiment of an apparatus for additive manufacturing of reinforced structures according to an embodiment of the invention;

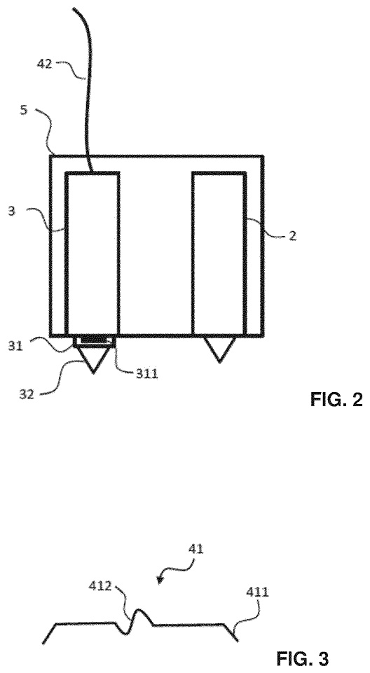

FIG. 2 shows a detailed view of a movement unit for the apparatus of FIG. 1; and

FIG. 3 shows a reinforcement fibre to be used according to the invention.

In FIG. 1, the apparatus 1 for additive manufacturing of reinforced structures is shown to exemplify an embodiment of the invention.

The apparatus 1 comprises a nozzle device 2 and a fiber device 3 which are arranged at a movement unit 5.

The nozzle device 2 is connected to a source for building material 2 what can be a mixer for example. The nozzle device 2 can be moved in a print direction X along a line or a curve for extruding the building material 21 to form the construction element 211. For curvature extrusion, a respective movement means (for example a rotation axle) can be provided to allow the fibre device to follow the nozzle device in a defined manner.

The fiber device 3 provides a reinforcement metal fibre 41 of a predetermined length from a continuous metal wire 42. Such a “ready made steel fibre” can be, for example, of the length in the range of 40 mm to 80 mm, in particular 50 mm to 70 mm.

The fibre device 3 comprises a wire feeding unit 43 for providing the continuous metal wire 42 from a metal wire storage 4. The fiber device 3 might comprise an electric wire feeder which continuously transports separately stored wires. Alternatively, to the situation as shown, the wire feeding unit 43 can be unified with or placed directly at the metal wire storage 4. Transport can be effected by pushing and/or tearing.

The movement unit 5 has arranged thereon the nozzle device 2 and the fibre device 3 in a fixed position relative to each other so that during a movement in the print direction X, the fibre device 3 places the reinforcement metal fibre 41 at the building material 21 extruded by the nozzle device 2. The extruded building material 21 includes material which has been extruded and which will be extruded. That means that the reinforcement metal fibre 41 can be used to connect different layers of extruded building material 21.

In the shown example, the nozzle device 2 and the fibre device 3 place the reinforcement metal fibre 41 at the building material 21 extruded by the fibre device 3 during a continuous movement in the print direction X.

The fibre device 3 is arranged and functions to allow for placing the reinforcement metal fibre 41 in the extruded building material 21 in a manner so that a portion of the reinforcement metal fibre 41 is outside of the building material 21. In that way the reinforcement metal fibre 41 can be placed in the already extruded building material 21 in a predetermined depth for example.

In the shown embodiment, the movement unit 5 comprises a robot having a robot arm 51 which is movable in 3D. The nozzle device 2 and the fibre device 3 are arranged in a position fixed relative to each other at the robot arm end 511.

The apparatus can be used for additive manufacturing of reinforced structures, comprising the steps of
a) extruding a building material 21 along a print direction X; and
b) providing a reinforcement metal fibre 41 of a predetermined length at the extruded building material 21.

Preferably, the step b) of providing a reinforcement metal fibre 41 of a predetermined length comprises cutting the reinforcement metal fibre 41 of a predetermined length from a continuous metal wire 42.

Preferably, the step b) of providing a reinforcement metal fibre 41 of a predetermined length comprises bending one or both end portions 411 and/or a middle portion 412 of the reinforcement metal fibre 41 before being placed in the building material 21.

Preferably, step b) of providing a reinforcement metal fibre 41 of a predetermined length comprises placing the reinforcement metal fibre 41 in a manner so that only a portion is inside the extruded building material 21.

Preferably, the method further comprises the step c) extruding a building material 21 along a print direction X at the reinforcement metal fibre 41 of a predetermined length placed at the extruded building material 21 so that so that only a portion is inside the extruded building material 21 in a manner so that the portion outside the extruded building material 21 is covered by the building material 21 extruded in step c).

In FIG. 2 a detailed view of a movement unit 5 for the apparatus of FIG. 1 is illustrated.

The fibre device 3 comprises a cutting unit 31 for cutting the continuous metal wire 42 provided from the wire feeding unit (not shown) into a reinforcement metal fiber 41 of a pre-determined length. The cutting unit 31 comprises a continuous cutting element 311 for separating the continuous wire.

The fibre device 3 comprises a shaping unit 32 capable of forming at least a portion of the reinforcement metal fiber 41 before being placed in the building material 21.

An example for such a shaped reinforcement metal fiber 41 is shown in FIG. 3. The reinforcement metal fibre 41 of a predetermined length (what includes a certain tolerance) and is bent at both end portions 411 as well as in a middle portion 412, wherein the shown bending shape can vary.

1. Apparatus for additive manufacturing of reinforced structures, comprising a nozzle device for extruding a building material along a print direction and a fibre device for providing a reinforcement metal fiber of a predetermined length from a continuous metal wire wherein the apparatus further comprises a movement unit having arranged thereon the nozzle device and the fibre device in a manner so that during a movement in the print direction the fibre device places the reinforcement metal fibre at the building material extruded by the nozzle device.

2. Apparatus for additive manufacturing according to claim 1, wherein the fibre device places the reinforcement metal fibre at the building material extruded by the nozzle device during a continuous movement in the print direction.

3. Apparatus for additive manufacturing according to claim 1, wherein the fibre device is designed to allow for placing the reinforcement metal fibre in the extruded building material in a manner so that a portion of the reinforcement metal fibre is outside of the building material.

4. Apparatus for additive manufacturing according to claim 1, wherein the fibre device comprises a wire feeding unit for providing the continuous metal wire from a metal wire storage.

5. Apparatus for additive manufacturing according to claim 1, wherein the fibre device comprises a cutting unit for cutting the continuous metal wire provided from the wire feeding unit into a reinforcement metal fiber of a pre-determined length.

6. Apparatus for additive manufacturing according to claim 5, wherein the cutting unit comprises a continuous cutting element.

7. Apparatus for additive manufacturing according to claim 1, wherein the fibre device comprises a shaping unit capable of forming at least a portion of the reinforcement metal fiber before being placed in the building material.

8. Apparatus for additive manufacturing according to claim 1, wherein the movement unit comprises a robot having a robot arm which is movable in 20 or 30, and wherein the nozzle device and the fibre device are arranged at a robot arm end.

9. Method for additive manufacturing of reinforced structures, comprising the steps of
a) extruding a building material along a print direction; and
b) providing a reinforcement metal fibre of a predetermined length at the extruded building material.

10. Method according to claim 9, wherein the step b) of providing a reinforcement metal fibre of a predetermined length comprises cutting the reinforcement metal fibre of a predetermined length from a continuous metal wire.

11. Method according to claim 9, wherein the step b) of providing a reinforcement metal fibre of a predetermined length comprises bending one or both end portions and/or a middle portion of the reinforcement metal fibre before being placed in the building material.

12. Method according to any one of the claim 9, wherein the step b) of providing a reinforcement metal fibre of a predetermined length comprises placing the reinforcement metal fibre in a manner so that only a portion is inside the extruded building material.

13. Method according to claim 12, wherein the method further comprises the step c) extruding a building material along a print direction at the reinforcement metal fibre of a predetermined length placed at the extruded building material so that so that only a portion is inside the extruded building material in a manner so that the portion outside the extruded building material is covered by the building material extruded in step c).
